(19) United States
(12) Patent Application Publication
(10) Pub. No.: US 2026/0080677 A1
(43) Pub. Date: Mar. 19, 2026

(54) METHOD, APPARATUS, DEVICE AND MEDIUM FOR OBJECT PROCESSING BASED ON PRE-TRAINING AND TWO-PHASE DEPLOYMENT

(71) Applicants: Beijing Youzhuju Network Technology Co., Ltd., Beijing (CN); Lemon Inc., Grand Cayman (KY)

(72) Inventors: Yifeng Chen, Beijing (CN); Fei Yu, Beijing (CN); Feihuang Yuan, Beijing (CN); Gengjie Xia, Beijing (CN); Shuchang Qin, Singapore (SG); Song Bai, Singapore (SG)

(21) Appl. No.: 19/102,347

(22) PCT Filed: Mar. 7, 2024
(86) PCT No.: PCT/CN2024/080632

§ 371 Date: Feb. 7, 2025

(30) Foreign Application Priority Data
Apr. 6, 2023 (CN) 202310363149.5

(51) Int. Cl. G06V 10/94; G06V 10/70; G06V 10/764; G06V 10/77; G06V 10/774

(52) U.S. Cl. CPC G06V 10/945; G06V 10/764; G06V 10/7715; G06V 10/774; G06V 10/87

(57) ABSTRACT

Embodiments of the disclosure provide a method, an apparatus, a device and a storage medium for object processing. The method for object processing includes: in response to receiving a predetermined operation by a user on a first selection control for pre-trained at least one generic model presented in a user interface, selecting the at least one generic model; at least acquiring at least one generic feature that is generated by the at least one generic model and associated with a sample of an object of a target category among a plurality of categories; and training an individual model for processing the object of the target category at least based at least on the at least one generic feature and annotation information of the sample of the object of the target category. Therefore, the efficiency of model training can be improved.

This application is based on and claims priority to Chinese Patent Application No. 202310363149.5, filed on Apr. 6, 2023, and entitled “METHOD, APPARATUS, DEVICE AND MEDIUM FOR OBJECT PROCESSING BASED ON PRE-TRAINING AND TWO-PHASE DEPLOYMENT”, the disclosure of which is incorporated herein by reference in its entirety.

### FIELD

Example embodiments of the present disclosure generally relate to the field of computers, in particular to a method, an apparatus, a device and a computer-readable storage medium for object processing.

### BACKGROUND

With the development of machine learning technologies, it has become possible to perform tasks in various application environments using machine learning models. Since different tasks have different processing requirements, processing with the fixed machine learning models will not be able to meet processing requirements under different scenarios, so different tasks need different machine learning models (e.g., an image recognition task requires an image processing model, an image classification task requires an image classification model, etc.). However, it takes a lot of time to train the machine learning models based on a large number of data, which leads to poor efficiency in training a plurality of machine learning models separately in a multi-task scenario. Therefore, how to improve the efficiency of model training is an urgent technical problem to be solved.

### SUMMARY

In a first aspect of the present disclosure, a method for object processing is provided. The method includes: in response to receiving a predetermined operation by a user on a first selection control for pre-trained at least one generic model presented in a user interface, selecting the at least one generic model; at least acquiring at least one generic feature that is generated by the at least one generic model and associated with a sample of an object of a target category among a plurality of categories; and training an individual model for processing the object of the target category at least based at least on the at least one generic feature and annotation information of the sample of the object of the target category.

In a second aspect of the present disclosure, an apparatus for object processing is provided. The apparatus includes: a model selection module configured to in response to receiving a predetermined operation by a user on a first selection control for pre-trained at least one generic model presented in a user interface, select the at least one generic model; a feature acquisition module configured to at least acquire at least one generic feature that is generated by the at least one generic model and associated with a sample of an object of a target category among a plurality of categories; and a model training module configured to train an individual model for processing the object of the target category at least based at least on the at least one generic feature and annotation information of the sample of the object of the target category.

In a third aspect of the present disclosure, an electronic device is provided. The electronic device includes at least one processing unit and at least one memory, wherein the at least one memory is coupled to the at least one processing unit and stores instructions executable by the at least one processing unit. The instructions, when executed by the at least one processing unit, cause the electronic device to perform the method in the first aspect.

In a fourth aspect of the present disclosure, a computer-readable storage medium is provided. A computer program is stored on the medium, and when executed by a processor, causes the processor to implement the method in the first aspect.

It would be appreciated that the content described in the Summary section is neither intended to define key or essential features of the embodiments of the present disclosure, nor is it intended to limit the scope of the present disclosure. Other features of the present disclosure will be readily understood through the following descriptions.

### BRIEF DESCRIPTION OF THE DRAWINGS

The above and other features, advantages and aspects of the embodiments of the present disclosure will become more apparent in combination with the accompanying drawings and with reference to the following detailed descriptions. In the drawings, the same or similar reference symbols refer to the same or similar elements, in which:

FIG. 1 is a schematic diagram of a model training and application environment in which the embodiments of the present disclosure can be implemented;

FIG. 2 is a flowchart of a process for object processing according to some embodiments of the present disclosure;

FIG. 3 is a schematic diagram of a process for model selection according to some embodiments of the present disclosure;

FIG. 4 is a schematic diagram of a user interface according to some embodiments of the present disclosure;

FIG. 5 is a schematic flowchart of a process for generating a fusion feature according to some embodiments of the present disclosure;

FIG. 6 is a schematic diagram of a process for model training according to some embodiments of the present disclosure;

FIG. 7 is a schematic diagram of models corresponding to different downstream tasks according to some embodiments of the present disclosure;

FIG. 8 is a schematic diagram of a pre-trained generic model according to some embodiments of the present disclosure;

FIG. 9 is a block diagram of an apparatus for object processing according to some embodiments of the present disclosure; and

FIG. 10 is a block diagram of an electronic device capable of implementing one or more embodiments of the present disclosure.

### DETAILED DESCRIPTION

The following describes embodiments of the present disclosure in detail with reference to the accompanying drawings. Although some embodiments of the present disclosure are shown in the accompanying drawings, it should be understood that the present disclosure may be implemented in various forms, and should not be construed as being limited to the embodiments described herein. On the contrary, these embodiments are provided such that the present disclosure will be thoroughly and completely understood. It should be understood that the accompanying drawings and embodiments of the present disclosure are merely used as examples, but are not intended to limit the protection scope of the present disclosure.

In descriptions of embodiments of the present disclosure, the term “include” and similar terms thereof should be understood as open inclusion, that is, “include but is not limited to”. The term “based” should be understood as “at least partially based on”. The terms “one embodiment” or “the embodiment” should be understood as “at least one embodiment”. The term “some embodiments” should be understood as “at least some embodiments”. Other explicit and implicit definitions may also be included below. As used herein, the term “model” may represent the correlation between individual pieces of data. For example, the above correlation may be acquired based on various technical solutions that are currently known and/or will be developed in the future.

It can be understood that data involved in this technical solution (including, but is not limited to, the data itself, and the acquisition or use of the data) shall comply with the requirements of the corresponding laws and regulations and relevant provisions.

It can be understood that before using the technical solutions disclosed in the embodiments of the present disclosure, a user should be informed of the type, the scope of use, the use scenario, and the like of personal information involved in the present disclosure in accordance with the relevant laws and regulations, and the user's authorization should be obtained in appropriate fashions.

For example, in response to receiving an active request from a user, prompt information is sent to the user to expressly prompt the user that an operation that the user requests to perform needs to acquire and use personal information of the user, to allow the user to choose, according to the prompt information, whether to provide the personal information to software or hardware such as an electronic device, an application program, a server or a storage medium that performs the operations in the technical solutions of the present disclosure.

As an optional but non-limiting embodiment, in response to receiving the active request from the user, a fashion of sending the prompt information to the user may be, for example, a fashion of a pop-up window, and the prompt information may be presented in a text fashion in the pop-up window. In addition, the pop-up window may further carry selection controls for the user to choose whether to “accept” or “decline”the provision of the personal information to the electronic device.

It can be understood that the above process of giving a notification and acquiring user's authorization is only schematic and does not constitute any limitation on the embodiments of the present disclosure, and other fashions complying with the relevant laws and regulations may be applied to the embodiments of the present disclosure.

As used herein, the term “model” may be used to learn an association relationship between corresponding inputs and outputs from training data. Therefore, after training, a corresponding output can be generated for a given input. A model may be generated based on a machine learning technology. Deep learning is a machine learning algorithm that processes inputs and provides corresponding outputs by using multiple layers of processing units. A neural network model is an example of a deep-learning-based model. In this specification, a “model” may also be referred to as a “machine learning model”, a “learning model”, a “machine learning network” or a “learning network”, and these terms are used interchangeably herein.

A “neural network” is a deep-learning-based machine learning network. A neural network can process inputs and provide corresponding outputs, and usually includes an input layer, an output layer, and one or more hidden layers between the input layer and the output layer. A neural network used in a deep learning application usually includes many hidden layers, to increase the depth of the network. The layers of the neural network are connected in sequence, such that an output of the previous layer is provided as an input of a next layer. The input layer receives an input of the neural network, and an output of the output layer is used as a final output of the neural network. Each layer of the neural network includes one or more nodes (also referred to as processing nodes or neurons), and each node processes an input from the previous layer.

Generally, machine learning may essentially include three processes, namely, a training process, a testing process, and an application process (also referred to as an inference process). In the training phase, a given model may be trained by using a large amount of training data, and parameter values are continuously and iteratively updated until the model can acquire consistent inference satisfying a desired goal from the training data. Through training, it may be considered that the model can learn associations from inputs to outputs (also referred to as input-to-output mappings) from the training data. The parameter values of the trained model are determined. In the testing process, test inputs are applied to the trained model to test whether the model can provide correct outputs, thereby determining the performances of the model. In the application process, the model may be used to process actual inputs based on the parameter values obtained from training to determine corresponding outputs.

As briefly mentioned above, different tasks require different machine learning models. For example, different machine learning models may be constructed for different tasks, and the machine learning models may be trained using training data that is associated with the tasks and contains manual annotation information. However, this way of separately training a plurality of machine learning models is less efficient. Moreover, different machine learning models require different training data, resulting in the machine learning models depending on a lot of annotation information, which in turn leads to high model training cost. In addition, the trained machine learning models have poor generalization ability, and their performance decays rapidly with time.

An embodiment of the present disclosure provides a solution for object processing. Generally, the solution proposes an architecture of a two-phase model, in which different types of models are used in different phases. Specifically, a generic model suitable for processing various types of objects (such as images of various articles, audios of various languages, or characters of various languages) is used in one phase, and an individual model suitable for processing specific target types of objects (such as images of certain articles, audios of certain languages, or characters of certain languages) is used in the other phase. According to this solution, after the generic model is pre-trained, a generic feature generated by the pre-trained generic model is acquired for a sample of a target type of object, and then the individual model is trained based on the generic feature and annotation information of the sample.

As will be appreciated from the following descriptions, by adopting the two-phase deployment mode in which the generic model is used as one phase and the individual model is used as the other phase, for any downstream task, there is a uniformly deployed generic model and a separately deployed individual model associated with the downstream task, thereby improving the flexibility of model application. In this way, the efficiency of model training and the generalization ability can be improved.

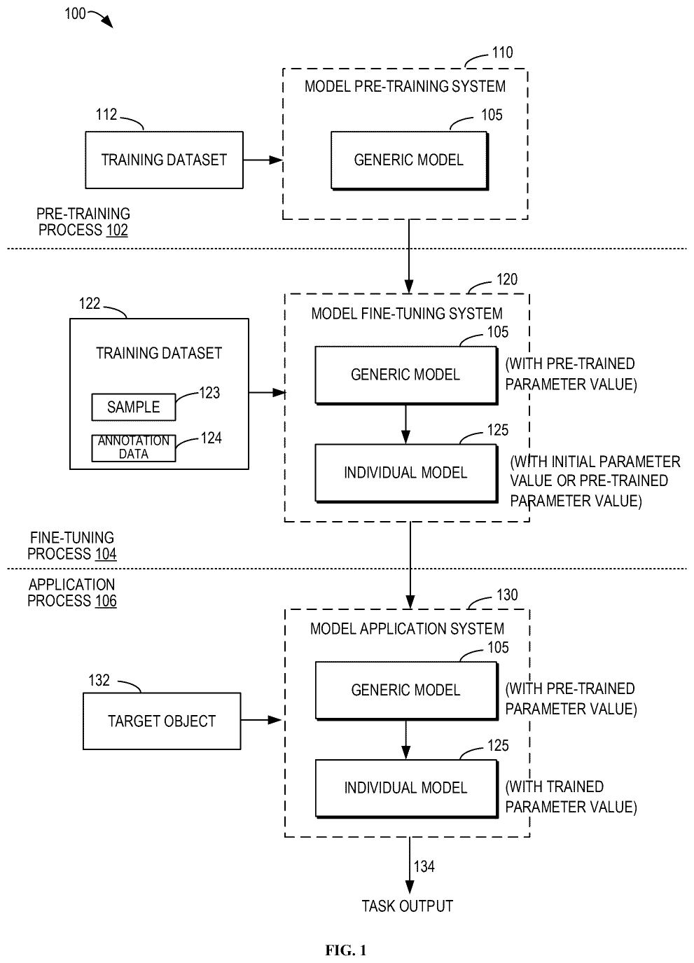

FIG. 1 is a schematic diagram of a model training and application environment 100 in which the embodiments of the present disclosure can be implemented. In the environment 100 of FIG. 1, three different processes for model processing are illustrated, including a pre-training process 102, a fine-tuning process 104 and an application process 106. In some cases, upon completion of the pre-training or fine-tuning process, there may also be a testing process (not shown in the figure) for testing an output result of a finely tuned model.

In the pre-training process 102, a model pre-training system 110 is configured to pre-train a generic model 105 using a training dataset 112. At the beginning of pre-training, the generic model 105 may have an initial parameter value. The purpose of the pre-training process is to update a parameter value of the generic model 105 into an expected value based on training data. In the pre-training process, one or more pre-training tasks may be designed, and each pre-training task is intended to help update parameters of the generic model 105. In some examples in which an image encoder is included in the generic model 105, one or more pre-training tasks may require that the generic model 105 is connected to the image decoder related to the pre-training task(s).

In the pre-training process 102, the generic model 105 may learn the generalization ability by means of a large scale of training data. Upon completion of the pre-training, the parameter value of the generic model 105 is updated, and thus the generic model has a pre-trained parameter value. Compared with an untrained original state, the pre-trained generic model 105 can achieve extraction of a feature representation more accurately.

A model fine-tuning system 120 may correspondingly finely tune the pre-trained generic model 105 in the fine-tuning process 104 with respect to different downstream tasks. In some embodiments, the downstream tasks may involve various visual tasks, and examples of such tasks include, but are not limited to, image classification, target detection, semantic segmentation, etc., which, of course, are merely illustrative and not intended to limit the scope of the present disclosure. Any other type of downstream task is applicable to the ideas and principles described herein. In some embodiments, given that different downstream tasks may have different inputs, the pre-trained generic model 105 may be correlated or “connected” with an individual model 125 required by the downstream task according to the specific downstream task.

In the fine-tuning process 104, in some embodiments, a training dataset 122 may be in a binary format and include a sample 123 and annotation information 124 related to the sample. In such an embodiment, the model fine-tuning system 120 may perform model training using the training dataset 122 that includes both the sample 123 and the annotation information 124. Specifically, the training process may be iteratively performed using training data.

The generic model 105 may extract a generic feature from the sample 123 in the training dataset 122 and provide the extracted generic feature to the individual model 125 to be trained. At the beginning of fine-tuning, the individual model 125 has an initial parameter value or a pre-trained parameter value. The individual model 125 performs, based on the feature, processing required by the downstream task. The difference between the obtained processing result and the annotation information 124 is adopted to update the parameter value of the model. In some embodiments, in the fine-tuning process 104, the respective parameter values of the generic model 105 and the individual model 125 may be updated, based on the training data, into expected values corresponding to the downstream tasks. In some embodiments, the parameter value of the pre-trained generic model 105 remains unchanged, and only the parameter value of the individual model 125 is updated in the fine-tuning process.

In the application process 106, the individual model 125 with the trained parameter values may be provided to a model application system 130 for use. In the application process 106, the generic model 105 and the individual model 125 may be used to process a corresponding input in a real scenario and provide a corresponding output. For example, the generic model 105 extracts a generic feature corresponding to a target object 132. The extracted generic feature is provided to the individual model 125 to determine the corresponding task output.

In FIG. 1, the model pre-training system 110, the model fine-tuning system 120 and the model application system 130 may include any computing system with a computing capability, such as various computing devices/systems, terminal devices and servers. The terminal device may be a mobile terminal, a fixed terminal or a portable terminal of any type, including a mobile phone, a desktop computer, a laptop computer, a notebook computer, a netbook computer, a tablet computer, a media computer, a multimedia tablet computer or any combination thereof, and accessories and peripherals of these devices or any combination thereof. The server includes, but is not limited to, a mainframe, an edge computing node, a computing device in a cloud environment, etc.

It should be understood that the components and arrangements in the environment 100 shown in FIG. 1 are merely illustrative, and a computing system suitable for implementing the example implementations described in the present disclosure may include one or more different components, other components and/or different arrangements. For example, although shown as being separate, the model pre-training system 110, the model fine-tuning system 120 and the model application system 130 may be integrated in the same system or device. Moreover, one or more of the model pre-training system 110, the model fine-tuning system 120 and the model application system 130 may be implemented in a plurality of systems or devices in a distributed manner. Implementations of the present disclosure will not be limited in this respect.

In some embodiments, instead of dividing the training process of the generic model 105 and the individual model 125 into the pre-training process and the fine-tuning process as shown in FIG. 1, a downstream task model may be directly constructed based on the task and a feature extraction model may be trained using a large amount of training data.

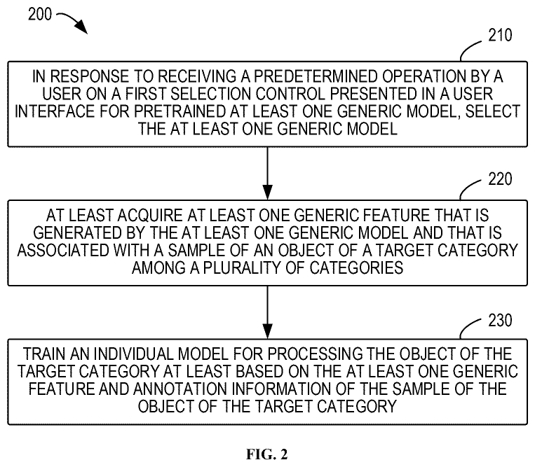

Some example embodiments of the present disclosure will be described below with continued reference to FIGS. 2 to 7.

FIG. 2 is a flowchart of a process 200 for object processing according to some embodiments of the present disclosure. In some embodiments, the process 200 may be implemented at the model fine-tuning system 120 shown in FIG. 1. For ease of discussion, the process 200 will be described with reference to the environment 100 of FIG. 1.

At block 210, in response to receiving a predetermined operation by a user on a first selection control presented in a user interface for pre-trained at least one generic model, the at least one generic model is selected.

In some embodiments, the pre-trained generic model provided by the model pre-training system 110 may be used, and a plurality of generic models provided by the model pre-training system 110 may be used due to different training datasets.

In some embodiments, the model pre-training system 110 may directly provide a plurality of generic models that are obtained by pre-training using different training datasets. Alternatively, in some other embodiments, the model pre-training system 110 may also provide only part of specific generic models based on corresponding instructions (for example, from the model fine-tuning system 120).

In some embodiments, since the downstream task may require a plurality of generic features extracted from a plurality of generic models, a user interface for model configuration may be presented, and a selection control (i.e., a first selection control) associated with model selection may be presented in the user interface. In some embodiments, the user interface may present a plurality of first selection controls, such that the user can select a plurality of generic models. In this way, the user can be assisted in selecting and configuring the plurality of generic models more intuitively and conveniently.

In response to receiving a predetermined operation by the user on the first selection control, at least one target generic model is selected from the plurality of generic models provided by the model pre-training system 110. In some embodiments, the predetermined operation may be, for example, a touch operation on the first selection control, including but not limited to a click operation, a long-press operation, a slide operation, and the like. In some embodiments, in the case where the first selection control includes an input entry associated with the generic model, the predetermined operation may also be a related operation on the input entry, and at least one target generic model may be determined based on a user input received at the input entry.

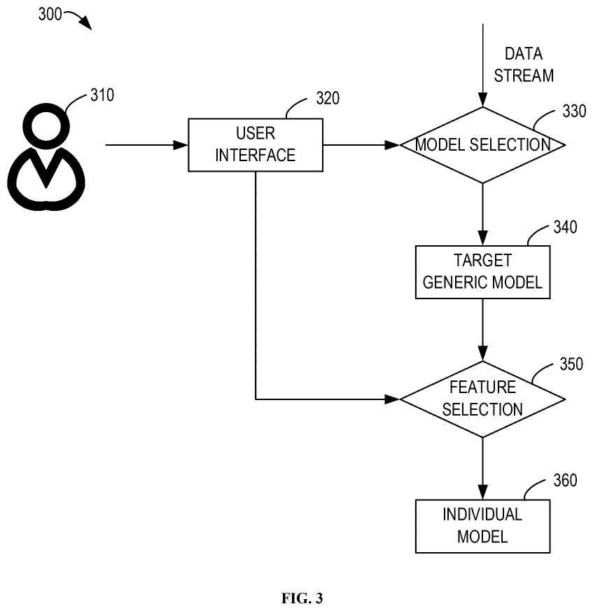

FIG. 3 is a schematic diagram of a process 300 for model selection according to some embodiments of the present disclosure. As shown, a user interface 320 for model selection 330 is presented to the user. At least one target generic model 340 may be determined based on a predetermined operation on the first selection control received in the user interface 320.

Referring back to FIG. 2, at block 220, at least one generic feature that is generated by the at least one generic model and that is associated with a sample of an object of a target category among a plurality of categories is acquired at least.

In some embodiments, at least one generic feature that is generated by the target generic model selected by the user from the user interface and is associated with the sample of the object of the target category may be acquired directly.

The generic feature has strong semantic information, but is of low resolution and therefore less perceptive of details. In order to make features acquired by an individual model required by the downstream task be multi-scale and multi-level features, in some embodiments, at least one intermediate feature generated by the target generic model and associated with the sample of the object of the target category may also be acquired. The intermediate feature has a higher resolution and contains more positional detailed information than the generic feature.

In some embodiments, a selection control (called a “second selection control”) for at least one intermediate feature of the target generic model is also included in the user interface for model configuration. In some embodiments, the second selection control may be presented in the user interface together with the first selection control. At this time, the first selection control and the second selection control may be presented in different areas of the user interface.

Alternatively, in some other embodiments, the second selection control may not be presented initially. If a predetermined operation by the user on the corresponding first selection control of the target generic model of at least one generic model is received, the second selection control for at least one intermediate feature of the target generic model is presented in the user interface. In some embodiments, the user interface may present a plurality of second selection controls, such that the user may select a plurality of intermediate features.

With continued reference to FIG. 3, upon determination of the at least one target generic model, at least one intermediate feature provided to the individual model 360 may be determined in response to the predetermined operation on the second selection control received in the user interface 320, and this process is called feature selection 350.

Similar to the first selection control, the predetermined operation on the second selection control may be, for example, a touch operation, such as a click operation, a long-press operation and a slide operation. In some embodiments, in the case where the second selection control contains an input entry associated with the intermediate feature, the predetermined operation may also be a related operation on the input entry, and at least one intermediate feature may be determined based on the user input received at the input entry.

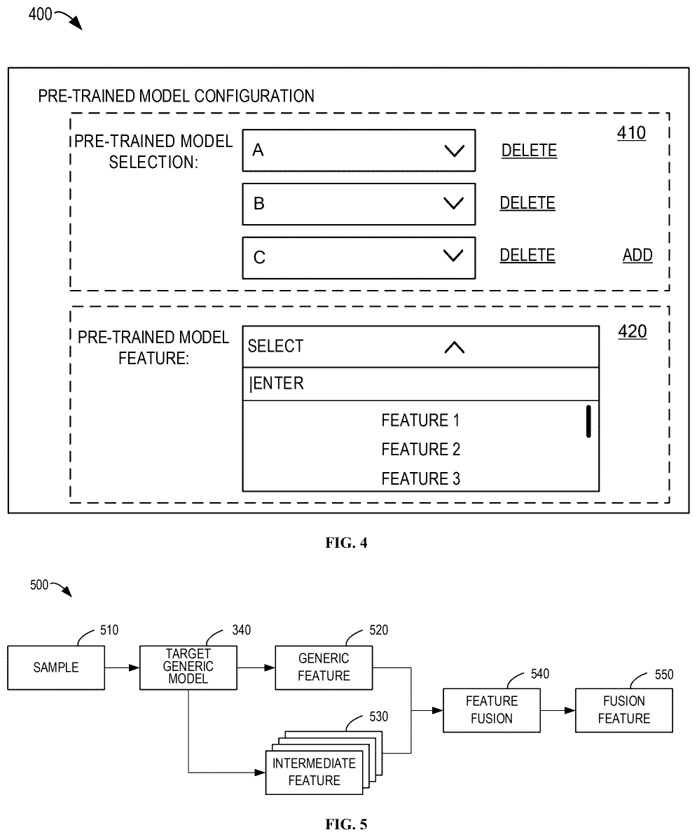

FIG. 4 is a schematic diagram of a user interface 400 according to some embodiments of the present disclosure. The user interface 400 presents an area 410 containing a plurality of first selection controls and an area 420 containing a second selection control. At least one target generic model may be determined in response to a predetermined operation, which is associated with the first selection control and received in the area 410 of the user interface 400, and at least one intermediate feature associated with the target generic model may be determined in response to a predetermined operation, which is associated with the second selection control and received in the area 420.

In some embodiments, upon acquisition of the generic feature and at least one intermediate feature generated by the target generic model, a fusion feature of the target generic model may also be generated based on the generic feature and the at least one intermediate feature.

FIG. 5 is a schematic diagram of a process 500 for generating a fusion feature according to some embodiments of the present disclosure. For an acquired sample 510, a generic feature 520 and a plurality of intermediate features 530, associated with the sample 510, are generated by the pre-trained target generic model 340. The generic feature 520 and the plurality of intermediate features 530 may be subjected to feature fusion 540 to obtain a fusion feature associated with the sample 510.

Compared with the solution of “single feature+linear classification” only using the generic feature, the solution of “multi-feature+feature fusion+linear classification” using the fusion feature obtained by performing feature fusion on the generic feature and the intermediate feature helps to improve the accuracy of the feature acquired by the individual model, which in turn improves the accuracy of processing by the individual model.

Referring back to FIG. 2, at block 230, an individual model for processing the object of the target category is trained at least based on the at least one generic feature and annotation information of the sample of the object of the target category.

The annotation information is a true value of the processing result indicated by the downstream task, i.e., an expected value of the processing result generated by the individual model 120 and associated with the sample. The annotation information of the sample may be acquired while the sample is acquired.

In some embodiments, in the case where at least one generic feature generated by at least one generic model and associated with the sample is acquired only, the processing result obtained by processing the generic feature by the individual model is acquired, and the difference between the processing result and the annotation information is determined.

In some embodiments, in the case where a fusion feature generated based on the generic feature and at least one intermediate feature is acquired, the individual model may be trained based on the fusion feature and the annotation information. Specifically, the processing result obtained by processing the fusion feature by the individual model is acquired, and the difference between the processing result and the annotation information is determined.

Further, the parameter value of the individual model may be adjusted based on the difference between the processing result and the annotation information, and the goal of training of the individual model is to at least make the difference less than a threshold. It should be noted that it is unnecessary to update the parameters of the pre-trained generic model at this time, and only the parameter value of the individual model is updated.

In some embodiments, the parameter value of the individual model may be updated using a loss function, and the loss function may be a distance loss function or a probability loss function. The distance loss function may include, for example, an L1 loss function, an L2 loss function, a Smooth L1 loss function, a Huber loss function, etc., and the probability loss function may include, for example, a KL divergence function, a cross-entropy loss function, a softmax loss function, etc., which are not limited in the embodiments of the present disclosure in this respect.

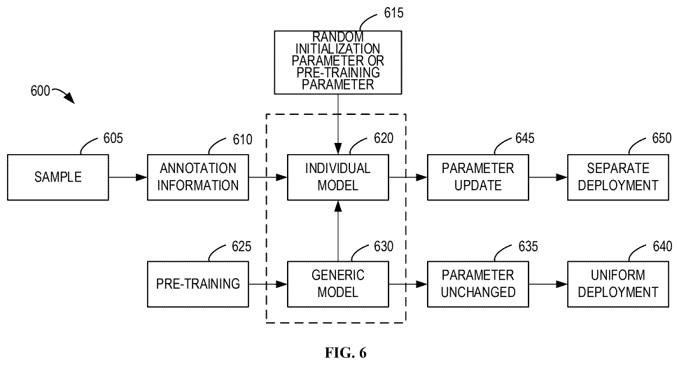

FIG. 6 is a schematic diagram of a process 600 for model training according to some embodiments of the present disclosure. For a sample 605, a generic feature generated by a pre-trained 625 generic model 630 and associated with the sample 605 is acquired at least, and the generic feature and annotation information 610 of the sample are provided to the individual model 630 all together. An individual model 620 has a random initialization parameter or a pre-training parameter 615 prior to training. The model fine-tuning system 120 determines the difference between a processing result generated by the individual model 620 and associated with the generic feature and the annotation information 610, and performs parameter update 645 on the individual model 620 based on the difference. Finally, the generic model 630 with an unchanged parameter 635 and the individual model 620 subjected to parameter update 645 are both applied to the downstream task.

In some embodiments, the generic model 630 is uniformly deployed 640 for different downstream tasks, i.e., different downstream tasks correspond to the same generic model 630. For different downstream tasks, the individual model 620 is separately deployed 650, i.e., different downstream tasks correspond to different individual models 620.

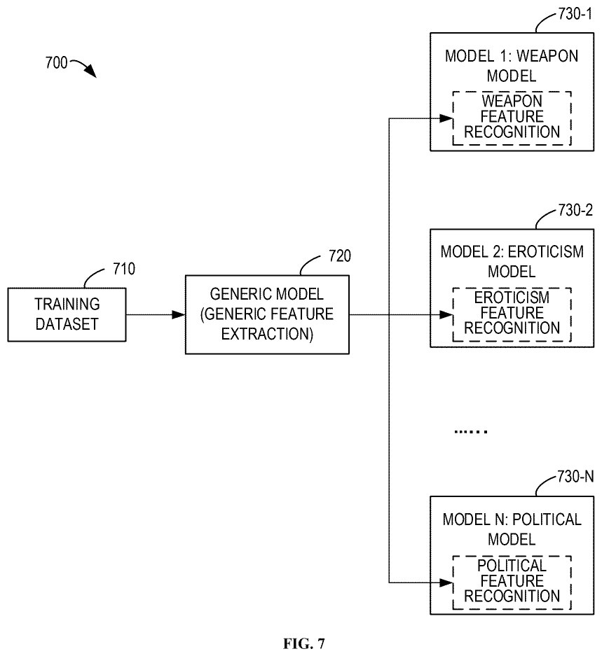

FIG. 7 is a schematic diagram of models corresponding to different downstream tasks according to some embodiments of the present disclosure. For different downstream tasks, different generic features corresponding to different training datasets 710 may be extracted by the same generic model 720. Further, different individual models are trained based on different generic features and the annotation information in the different training datasets 710 to obtain a specific individual model 730 for the downstream task. For example, when the downstream task is weapon feature recognition, the model fine-tuning system 120 may obtain, by means of training, a weapon model 730-1 for weapon feature recognition.

Therefore, by adopting a two-phase deployment method, for any downstream task, there may be a uniformly deployed generic model and a separately deployed individual model associated with the downstream task, which can improve the flexibility of model application.

Some example embodiments of the model fine-tuning system 120 have been described above in combination with various embodiments, and some example embodiments of the model pre-training system 110 will be described below with reference to the accompanying drawings.

In some embodiments, the generic model may be trained based on a training dataset containing large-scale data. Specifically, in the case where the generic model includes an encoder, a parameter value of the encoder in the generic model may be updated based on the training dataset, and the goal of pre-training is at least to enable the encoder to extract an appropriate generic feature from the dataset.

In some embodiments, the pre-trained training dataset contains various types of objects, including but not limited to, voice, images, text, etc. in order to make the generalization ability of the trained generic model stronger.

In some embodiments, when the object contained in the training dataset includes an image, the generic model at least includes an image encoder, and the generic model may generate, by the image encoder, an image feature associated with the image. In the case where the generic model further includes a text encoder, the generic model may be trained by means of image-text matching. In some embodiments, image information and text information of a training image sample in the training dataset may be acquired, and then the target generic model of at least one generic model may be pre-trained based on the matching degree between the image information and the text information.

Specifically, a plurality of image features are generated by the image encoder in the generic model based on the image information of the plurality of training image samples, and a plurality of text features are generated by the text encoder in the generic model based on the text information of the plurality of training image samples. Further, a matching degree between respective image features of the plurality of image features and respective text features of the plurality of text features is determined; and the image encoder and the text encoder are trained based on the matching degree. The goal of training is to increase a matching degree between an image feature and a corresponding text feature of a target training image sample among the plurality of training image samples, and to reduce a matching degree between the image feature of the target image sample and text features of other training image samples among the plurality of training image samples.

In some embodiments, the respective parameter values of the image encoder and the text encoder may be updated using a loss function based on the matching degree, so as to realize pre-training of the generic model. Like a loss function in the individual model, a loss function of the generic model may also be a distance loss function or a probability loss function.

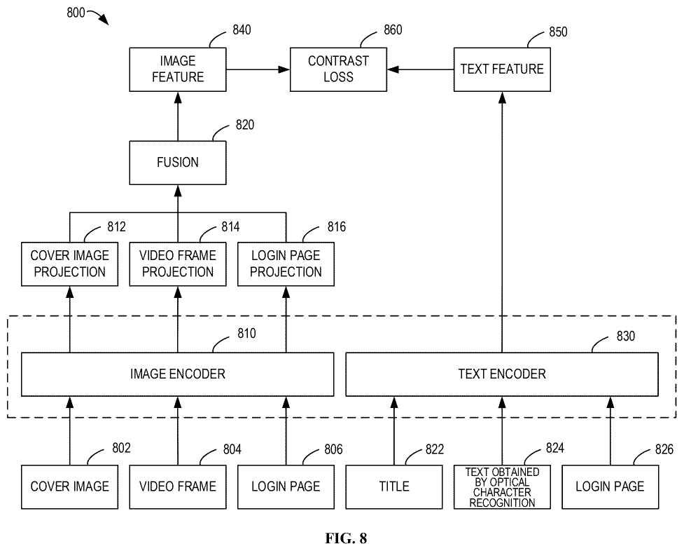

FIG. 8 is a schematic diagram of a pre-trained generic model 800 according to some embodiments of the present disclosure. An image encoder 810 and a text encoder 830 constitute a generic model 800. In FIG. 8, taking image information of a training image sample contained in a training dataset including a cover image 802, a video frame 804 and a login page 806 as an example, the image encoder 810 may generate three first image features respectively associated with the above three, namely, a cover image projection 812, a video frame projection 814 and a login page projection 816. Further, the model pre-training system 110 fuses 820 the three first image features to obtain a fused image feature 840. Meanwhile, text information of the training image sample contained in the training dataset, including a title 822, a text 824 obtained by optical character recognition and a login page 806, is provided to the text encoder 830, and the text encoder 830 may generate text features 850 associated with the above three. Finally, contrast loss 860 is performed based on the matching degree between the image feature 840 and the text feature 850, and the parameter values of the image encoder 810 and the text encoder 830 are updated based on a result, i.e., the parameter value of the generic model 800 is updated based on the matching degree.

In some embodiments, since the dataset for training the generic model contains a large scale of data, the generalization ability of the pre-trained generic model is strong. Therefore, the training dataset for training the individual model may be small in scale. In this way, the amount of data required for training the individual model can be reduced, such that the training efficiency of the individual model is higher, which in turn makes the model training efficiency for the downstream task higher.

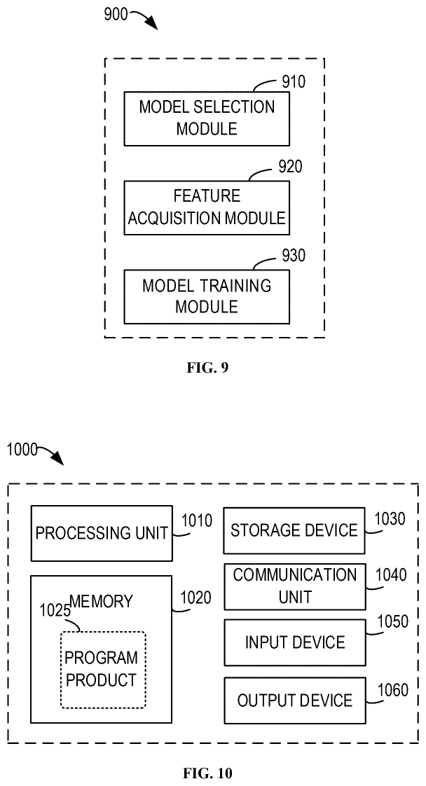

FIG. 9 is a block diagram of an apparatus 900 for object processing according to some embodiments of the present disclosure. For example, the apparatus 900 may be implemented or included in a model pre-training system 110 and/or a model fine-tuning system 120. Each module/component in the apparatus 900 may be implemented by hardware, software, firmware or any combination thereof.

As shown in the figure, the apparatus 900 includes a model selection module 910 configured to in response to receiving a predetermined operation by a user on a first selection control for pre-trained at least one generic model presented in a user interface, select the at least one generic model. The apparatus 900 further includes a feature acquisition module 920 configured to at least acquire at least one generic feature that is generated by the at least one generic model and associated with a sample of an object of a target category among a plurality of categories. The apparatus 900 further includes a model training module 930 configured to train an individual model for processing the object of the target category at least based at least on the at least one generic feature and annotation information of the sample of the object of the target category.

In some embodiments, the feature acquisition module 920 may also be configured to: in response to receiving a predetermined operation by the user on a first selection control corresponding to a target generic model of the at least one generic model, present in the user interface a second selection control for at least one intermediate feature of the target generic model; and in response to receiving a predetermined operation by the user on the second selection control, acquire the generic feature and at least one intermediate feature that are generated by the target generic model and that are associated with the sample of the object of the target category.

In some embodiments, the model training module 930 may also be configured to: generate a fusion feature based on the at least one intermediate feature and the generic feature; and train the individual model based on the fusion feature and the annotation information.

In some embodiments, the model training module 930 may also be configured to: generate, by the individual model, a processing result for the sample of the object of the target category based on the at least one generic feature; and train the individual model based on the processing result and the annotation information.

In some embodiments, the object includes an image; and the apparatus 900 further includes: an information acquisition module configured to acquire image information and text information of a plurality of training image samples; and a model pre-training module configured to pre-train a target generic model of the at least one generic model based on a matching degree between the image information and the text information.

In some embodiments, the target generic model includes an image encoder and a text encoder; and the model pre-training module may also be configured to: generate, by the image encoder, a plurality of image features based on the image information of the plurality of training image samples; generate, by the text encoder, a plurality of text features based on the text information of the plurality of training image samples; determine a matching degree between a respective image feature of the plurality of image features and a respective text feature of the plurality of text features; and train the image encoder and the text encoder to increase a matching degree between an image feature and a corresponding text feature of a target training image sample among the plurality of training image samples, and to reduce a matching degree between the image feature of the target image sample and a text feature of another training image sample among the plurality of training image samples.

FIG. 10 is a block diagram of an electronic device 1000 capable of implementing one or more embodiments of the present disclosure. It should be understood that the electronic device 1000 illustrated in FIG. 10 is merely illustrative and should not constitute any limitation on the functions or the scope of the embodiments described herein. The electronic device 1000 illustrated in FIG. 10 may be configured to implement a model pre-training system 110, a model fine-tuning system 120 and/or a model application system 130.

As shown in FIG. 10, the electronic device 1000 is in the form of a general-purpose electronic device. Components of the electronic device 1000 may include, but are not limited to, one or more processors or processing units 1010, a memory 1020, a storage device 1030, one or more communication units 1040, one or more input devices 1050, and one or more output devices 1060. The processing unit 1010 may be an actual or virtual processor and can execute various processing according to programs stored in the memory 1020. In a multi-processor system, a plurality of processing units executes computer-executable instructions in parallel to improve a parallel processing capability of the electronic device 1000.

The electronic device 1000 typically includes a plurality of computer storage mediums. Such mediums may be any available mediums accessible by the electronic device 1000, and include but are not limited to volatile and nonvolatile mediums, and removable and non-removable mediums. The memory 1020 may be a volatile memory (such as a register, a cache and a random access memory (RAM)), a nonvolatile memory (such as a read-only memory (ROM), an electrically erasable programmable read-only memory (EEPROM) and a flash memory) or some combinations thereof. The storage device 1030 may be a removable or non-removable medium and may include a machine-readable medium, such as a flash drive, a magnetic disk or any other mediums, which can be used to store information and/or data (such as training data for training) and may be accessed within the electronic device 1000.

The electronic device 1000 may further include additional removable/non-removable, volatile/nonvolatile storage mediums. Although not shown in FIG. 10, a disk drive for reading from or writing into a removable and nonvolatile magnetic disk (such as a “floppy disk”) and an optical disk drive for reading from or writing into a removable and nonvolatile optical disk may be provided. In these cases, each drive may be connected to a bus (not shown) by one or more data medium interfaces. The memory 1020 may include a computer program product 1025 having one or more program modules configured to execute various methods or actions according to various embodiments of the present disclosure.

The communication unit 1040 realizes communication with other electronic devices through a communication medium. Additionally, functions of the components of the electronic device 1000 may be implemented in a single computing cluster or a plurality of computing machines, and these computing machines can communicate through communication connections. Therefore, the electronic device 1000 may be operated in a networked environment by using logical connections with one or more other servers, a network personal computer (PC) or another network node.

The input device 1050 may be one or more input devices, such as a mouse, a keyboard and a trackball. The output device 1060 may be one or more output devices, such as a display, a speaker and a printer. The electronic device 1000 may also communicate with one or more external devices (not shown), such as storage devices and display devices, through the communication unit 1040 as needed, communicate with one or more devices that enable users to interact with the electronic device 1000, or communicate with any devices (such as network cards and modems) that enable the electronic device 1000 to communicate with one or more other computing devices. Such communication may be executed via an input/output (I/O) interface (not shown).

According to an example embodiment of the present disclosure, a computer-readable storage medium is provided and has a computer-executable instruction stored thereon, wherein the computer-executable instruction, when executed by a processor, causes the processor to implement the method described above. According to an example embodiment of the present disclosure, a computer program product is also provided, wherein the computer program product is tangibly stored on a non-transitory computer-readable medium and includes a computer-executable instruction, and the computer-executable instruction is executed by a processor to implement the method described above.

Various aspects of the present disclosure are described herein with reference to the flowcharts and/or block diagrams of the method, apparatus, device and computer program product implemented according to the present disclosure. It should be understood that each block of the flowcharts and/or block diagrams and combinations of various blocks in the flowcharts and/or block diagrams may be implemented by computer-readable program instructions.

These computer-readable program instructions may be provided to the processing unit of a general-purpose computer, a special-purpose computer or other programmable data processing apparatus to produce a machine, so that these instructions, when executed by the processing unit of the computer or other programmable data processing apparatus, produce the apparatus for implementing the functions/actions specified in one or more blocks in the flowcharts and/or block diagrams. These computer-readable program instructions may also be stored in a computer-readable storage medium, and these instructions enable the computer, the programmable data processing apparatus and/or other devices to work in a particular manner, so that the computer-readable medium having the instructions stored includes an article of manufacture including the instructions for implementing various aspects of the functions/actions specified in one or more blocks in the flowcharts and/or block diagrams.

The computer-readable program instructions may be loaded onto the computer, other programmable data processing apparatuses, or other devices, such that a series of operation steps are executed on the computer, other programmable data processing apparatuses, or other devices to produce a computer-implemented process. Therefore, the instructions executed on the computer, other programmable data processing apparatuses, or other devices implement the functions/actions specified in one or more blocks in the flowcharts and/or block diagrams.

The flowcharts and block diagrams in the figures show possibly implemented architectures, functions and operations of systems, methods and computer program products according to a plurality of embodiments of the present disclosure. In this regard, each block in the flowcharts or block diagrams may represent a module, a program segment or a part of instruction, and the module, the program segment or the part of instruction contains one or more executable instructions for implementing specified logical functions. In some alternative embodiments, the functions noted in the blocks may also occur in a different order than those noted in the figures. For example, two consecutive blocks may be actually executed substantially in parallel, and sometimes they may be executed in a reverse order, depending on the functions involved. It should also be noted that each block in the block diagrams and/or flowcharts and combinations of the blocks in the block diagrams and/or flowcharts may be implemented by a dedicated hardware-based system executing specified functions or actions, or may be implemented by a combination of dedicated hardware and computer instructions.

Various embodiments of the present disclosure have been described above, and the above descriptions are illustrative, are not exhaustive, and are not limited to the disclosed various embodiments. Many modifications and changes will be obvious to those of ordinary skill in the art without departing from the scope and spirit of the described various embodiments. The terminology used herein is chosen to best explain principles of various embodiments, practical application or improvement to technologies in the market, or to enable others of ordinary skill in the art to understand various embodiments disclosed herein.

1. A method for object processing, comprising:
in response to receiving a predetermined operation by a user on a first selection control for pre-trained at least one generic model presented in a user interface, selecting the at least one generic model;
at least acquiring at least one generic feature that is generated by the at least one generic model and associated with a sample of an object of a target category among a plurality of categories; and
training an individual model for processing the object of the target category at least based at least on the at least one generic feature and annotation information of the sample of the object of the target category.

2. The method according to claim 1, wherein at least acquiring the at least one generic feature comprises:
in response to receiving a predetermined operation by the user on a first selection control corresponding to a target generic model of the at least one generic model, presenting, in the user interface, a second selection control for at least one intermediate feature of the target generic model; and
in response to receiving a predetermined operation by the user on the second selection control, acquiring the generic feature and at least one intermediate feature that are generated by the target generic model and that are associated with the sample of the object of the target category.

3. The method according to claim 2, wherein training the individual model comprises:
generating a fusion feature based on the at least one intermediate feature and the generic feature; and
training the individual model based on the fusion feature and the annotation information.

4. The method according to claim 1, wherein training the individual model comprises:
generating, by the individual model, a processing result for the sample of the object of the target category based on the at least one generic feature; and
training the individual model based on the processing result and the annotation information.

5. The method according to claim 1, wherein the object comprises an image, and the method further comprises:
acquiring image information and text information of a plurality of training image samples; and
pre-training a target generic model of the at least one generic model based on a matching degree between the image information and the text information.

6. The method according to claim 5, wherein the target generic model comprises an image encoder and a text encoder, and pre-training the target generic model comprises:
generating, by the image encoder, a plurality of image features based on the image information of the plurality of training image samples;
generating, by the text encoder, a plurality of text features based on the text information of the plurality of training image samples;
determining a matching degree between a respective image feature of the plurality of image features and a respective text feature of the plurality of text features; and
training the image encoder and the text encoder to increase a matching degree between an image feature and a corresponding text feature of a target training image sample among the plurality of training image samples, and to reduce a matching degree between the image feature of the target image sample and a text feature of another training image sample among the plurality of training image samples.

7-12. (canceled)

13. An electronic device, comprising:
at least one processor; and
at least one memory, wherein the at least one memory is coupled to the at least one processor and stores instructions executable by the at least one processor, and the instructions, when executed by the at least one processor, cause the electronic device to perform acts comprising:
in response to receiving a predetermined operation by a user on a first selection control for pre-trained at least one generic model presented in a user interface, selecting the at least one generic model;
at least acquiring at least one generic feature that is generated by the at least one generic model and associated with a sample of an object of a target category among a plurality of categories; and
training an individual model for processing the object of the target category at least based at least on the at least one generic feature and annotation information of the sample of the object of the target category.

14. A non-transitory computer-readable storage medium having a computer program stored thereon, wherein the computer program, when executed by a processor, performs acts comprising:
in response to receiving a predetermined operation by a user on a first selection control for pre-trained at least one generic model presented in a user interface, selecting the at least one generic model;
at least acquiring at least one generic feature that is generated by the at least one generic model and associated with a sample of an object of a target category among a plurality of categories; and
training an individual model for processing the object of the target category at least based at least on the at least one generic feature and annotation information of the sample of the object of the target category.

15. The electronic device according to claim 13, wherein at least acquiring the at least one generic feature comprises:
in response to receiving a predetermined operation by the user on a first selection control corresponding to a target generic model of the at least one generic model, presenting, in the user interface, a second selection control for at least one intermediate feature of the target generic model; and
in response to receiving a predetermined operation by the user on the second selection control, acquiring the generic feature and at least one intermediate feature that are generated by the target generic model and that are associated with the sample of the object of the target category.

16. The electronic device according to claim 14, wherein training the individual model comprises:
generating a fusion feature based on the at least one intermediate feature and the generic feature; and
training the individual model based on the fusion feature and the annotation information.

17. The electronic device according to claim 13, wherein training the individual model comprises:
generating, by the individual model, a processing result for the sample of the object of the target category based on the at least one generic feature; and
training the individual model based on the processing result and the annotation information.

18. The electronic device according to claim 13, wherein the object comprises an image, and the acts further comprise:
acquiring image information and text information of a plurality of training image samples; and
pre-training a target generic model of the at least one generic model based on a matching degree between the image information and the text information.

19. The electronic device according to claim 18, wherein the target generic model comprises an image encoder and a text encoder, and pre-training the target generic model comprises:
generating, by the image encoder, a plurality of image features based on the image information of the plurality of training image samples;
generating, by the text encoder, a plurality of text features based on the text information of the plurality of training image samples;
determining a matching degree between a respective image feature of the plurality of image features and a respective text feature of the plurality of text features; and
training the image encoder and the text encoder to increase a matching degree between an image feature and a corresponding text feature of a target training image sample among the plurality of training image samples, and to reduce a matching degree between the image feature of the target image sample and a text feature of another training image sample among the plurality of training image samples.

20. The non-transitory computer-readable storage medium according to claim 14, wherein at least acquiring the at least one generic feature comprises:
in response to receiving a predetermined operation by the user on a first selection control corresponding to a target generic model of the at least one generic model, presenting, in the user interface, a second selection control for at least one intermediate feature of the target generic model; and
in response to receiving a predetermined operation by the user on the second selection control, acquiring the generic feature and at least one intermediate feature that are generated by the target generic model and that are associated with the sample of the object of the target category.

21. The non-transitory computer-readable storage medium according to claim 14, wherein training the individual model comprises:
generating a fusion feature based on the at least one intermediate feature and the generic feature; and
training the individual model based on the fusion feature and the annotation information.

22. The non-transitory computer-readable storage medium according to claim 14, wherein training the individual model comprises:
generating, by the individual model, a processing result for the sample of the object of the target category based on the at least one generic feature; and
training the individual model based on the processing result and the annotation information.

23. The non-transitory computer-readable storage medium according to claim 14, wherein the object comprises an image, and the acts further comprise:
acquiring image information and text information of a plurality of training image samples; and
pre-training a target generic model of the at least one generic model based on a matching degree between the image information and the text information.

24. The non-transitory computer-readable storage medium according to claim 23, wherein the target generic model comprises an image encoder and a text encoder, and pre-training the target generic model comprises:
generating, by the image encoder, a plurality of image features based on the image information of the plurality of training image samples;
generating, by the text encoder, a plurality of text features based on the text information of the plurality of training image samples;
determining a matching degree between a respective image feature of the plurality of image features and a respective text feature of the plurality of text features; and
training the image encoder and the text encoder to increase a matching degree between an image feature and a corresponding text feature of a target training image sample among the plurality of training image samples, and to reduce a matching degree between the image feature of the target image sample and a text feature of another training image sample among the plurality of training image samples.
